(19) United States
(12) Patent Application Publication
(10) Pub. No.: US 2007/0049144 A1
(43) Pub. Date: Mar. 1, 2007

(54) COAL TAR ENAMEL COATED BASE SHEETS

(76) Inventors: Kenneth J. Brzozowski, Chardon, OH (US); Warne T. Hall JR., Canton, OH (US)

Correspondence Address: Armand P. Boisselle;RENNER, OTTO, BOISSELLE & SKLAR, LLP, 19th Floor, 1621 Euclid Avenue, Cleveland, OH, 44115, US

(21) Appl. No.: 11/553,032

(22) Filed: Oct. 26, 2006

Related U.S. Application Data
(62) Division of application No. 10/850,013, filed on May 20, 2004.

(51) Int. Cl. B32B 5/02

(52) U.S. Cl. 442/59; 442/164; 442/168; 442/170; 442/64

(57) ABSTRACT

Base sheets, useful in roofing applications and in other waterproofing applications, are described which comprise (a) a fabric layer having an upper surface and a lower surface, and (b) a coating of a coal tar enamel on at least one surface of the fabric, the coating having an exposed outer surface. In one embodiment, a parting agent such as sand is applied to the coated enamel exposed surface(s) to prevent blocking (sticking) of the base sheet when stacked or formed into a roll.

### CROSS REFERENCE TO RELATED APPLICATION

This application is a division of copending U.S. application Ser. No. 10/850,013 filed on May 20, 2004.

### FIELD OF THE INVENTION

The present invention relates to waterproof base sheets and more particularly to base sheets having a coating of coal tar enamel. The present invention also relates to base sheets which are useful in roofing and other waterproofing applications.

### BACKGROUND OF THE INVENTION

Built-up roofing (BUR) systems generally comprise a substantially rigid deck followed by insulating layer(s) covered with a membrane comprising multiple layers of bitumen, impregnated or coated reinforcing sheets adhered to each other with a field applied bitumen adhesive application of some type, and covered with a protective layer of small stones or other inert mineral aggregate materials embedded in and covering the top bitumen coating. BUR is used primarily on educational, industrial and commercial buildings which have flat or low-slope roofing systems. Its popularity arises from its relatively low cost combined with its effectiveness as a water repellant membrane and its durability.

The substrate or deck can be made of gypsum, cement, wood, metals or a synthetic material sufficient to provide structural integrity to the roofing assembly.

The insulating layer(s) is constructed of a rigid or semi-rigid material to reduce thermal passage and includes such materials as perlite, polystyrene, polyurethane, polyisocyanurate, fiberboard and foamed glass.

Known base sheets are composed of an organic or inorganic material, saturated and/or coated with oxidized or unoxidized asphalt, or polymer modified asphalt. The top and bottom surfaces of the base sheet are coated with an asphaltic material and, in some applications, granules or particulates are embedded to allow the sheet to create a ventilation layer. The base sheet is treated with a release agent, such as sand, talc or a soap to prevent sticking (blocking) between the layers when the sheet is rolled for shipping.

### SUMMARY

In one embodiment of the present invention, base sheets are described which comprise:

(a) a fabric layer having an upper surface and a lower surface, and

(b) a coating of a coal tar enamel on at least one surface of the fabric, the coating having an exposed outer surface.

In another embodiment, the base sheets of the present invention also comprise (c) a parting agent on the exposed surface or surfaces of the coal tar enamel. The coal tar enamel coated base sheets of the present invention are useful in a variety of applications including as base sheets over decks, as ply sheets in cold process roof assemblies and as a base sheet and/or flashing with coal tar or asphalt built-up roofs (BURS). In one embodiment, the coal tar enamel coated base sheets of the invention are waterproof and exhibit desirable tear strength and elongation properties. The coal tar coated base sheets of the invention when used in roofing systems provide one or more of the following desirable results: they reinforce the bitumen used in the roofing system; they assist in obtaining the quantity of bitumen desired in the particular roofing application; they improve the bitumen's resistance to traffic during and after application; they assist in reducing or eliminating bitumen migration due to heat load; and they may modify the fire characteristics of the BUR. The coal tar enamel coated base sheets of the present invention also are useful in a variety of waterproofing applications including above and below grade.

### DETAILED DESCRIPTION

The present invention is directed, in one embodiment, to base sheets comprising (a) a fabric layer having an upper surface and a lower surface, and (b) a coating of a coal tar enamel on at least one surface of the fabric, the coating having an exposed outer surface.

The fabric layer utilized in the base sheets of the present invention may be felts or mats which include woven fabrics, non-woven fabrics and knitted fabrics. The fabric sheets also may be referred to as carry mats and membranes. Felts generally are defined as non-woven flexible sheets manufactured by the random interlocking of fibers with a binder or through a combination of mechanical work, moisture or heat. The fabric layers which are utilized in the base sheet of the present invention may be composed of inorganic materials such as glass, or organic materials such as organic polymeric materials, or mixtures of organic and inorganic materials. In one embodiment, the fabric layers comprise fibers and/or filaments selected from glass, polymeric materials, and mixtures thereof. Examples of useful polymeric materials include polyesters, polyamides, and polyolefins such as polypropylene.

Useful fiberglass fabrics are available from a variety of sources. Non-woven fabrics generally comprise fiberglass and one or more binders to set the glass strands into a stable fabric or membrane. The glass strands may be varied in length and diameter, and these can have an affect on the weight and strength of the fabric. Fiberglass fabrics are strong and light, as well as more heat resistant than the polymer fabrics. One of the advantages of the use of fiberglass fabrics in the present invention is that the fiberglass provides the strength and thermal stability to the fabric while the hot coal tar enamel is applied to the fabric and thereafter cooled.

Useful polymer fabrics also are available from several commercial sources. Like the fiberglass fabrics, non-woven polymer fabrics comprise polymer strands and one or more binders, and the polymer strands utilized in the fabric may vary in length and diameter. Since most useful polymers have lower melting points than the glass strands used in fiberglass fabrics, the temperature of the heated coal tar enamel coated onto polymer fabrics must be lower than the temperature of the enamel applied to fiberglass. In one embodiment the temperature of the coal tar enamel applied to polymer fabrics (e.g., 100% polymer or mixtures of fiberglass and polymer) should not exceed the melting point of the polymer strands present. Generally, it is desirable to utilize polyesteror polypropylene containing fabrics since the polyesters and polypropylenes provide fabrics having desirable strength, elongation and tear strength properties.

Knitted fabrics also may be used in preparing the coal tar enamel coated base sheets of the invention. The knitted fabrics may comprise fiberglass, polymer fibers, or mixtures thereof. The fabrics are knitted in such a manner to achieve lightweight fabrics having high levels of strength and tear resistance. Accordingly, the knitted fabrics incorporated into the base sheets of the invention can provide coated base sheets having the desired tear strength and tear resistance at thicknesses or weights significantly less than required for the non-woven fabrics.

The weight and/or thickness of the fabric layer may be varied over a wide range, and in one embodiment, the weight of the fabric layer may range from about 1 to about 10 or even 15 pounds per 100 square feet of fabric. For example, the fabric layers may comprise: non-woven fiberglass at a weight of about 1.5 pounds per 100 square feet; non-woven polyester at a weight of about 3.5 pounds per 100 square feet; non-woven polypropylene at about 2.5 pounds per 100 square feet; a non-woven fiberglass/polyester combination at about 3.8 pounds per 100 square feet; and a knitted combination of fiberglass/polyester at a weight of about 10 pounds per 100 square feet.

Specific examples of useful fabric layer materials which are available commercially are listed in the following table.

| | Designa- | | Composi- | | |
|---|---|---|---|---|---|
| Source | tion | Type | tion | Weight | |
| Johns | Duramat | Non-woven | Fiberglass | 1.85 | lbs/100 F² |
| Manville | 7542 | | | | |
| Elk | BUR MAT | Non-woven | Fiberglass | 1.5 | lbs/100 F² |
| Elk | BUR MAT | Non-woven | Fiberglass | 1.7 | lbs/100 F² |
| Elk | BUR MAT | Non-woven | Fiberglass | 1.9 | lbs/100 F² |
| Elk | BUR MAT | Non-woven | Fiberglass | 2.35 | lbs/100 F² |
| Scrimco | 50007 | Non-woven | Fiberglass | 4.1 | lbs/100 F² |
| Scrimco | 50018 | Non-woven | Fiberglass | 4.6 | lbs/100 F² |
| Johns | Trevira | Non-woven | Polyester | 170 | g/m² |
| Manville | 170 | | | | |
| Tamko | Spunbonded | Non-woven | Polyester | 170 | g/m² |
| | 170 | | | | |
| Colbond | Spunbonded | Non-woven | Polyester | 175 | g/m² |
| | 175 | | | | |
| Colback | Thermally | Non-woven | Polyester | 175 | g/m² |
| | Bonded 175 | | | | |
| Johns | 055-170 | Non-woven | Fiberglass | 170 | g/m² |
| Manville | | | and | | |
| | | | Polyester | | |
| Colbond | SDM-175 | Non-woven | Fiberglass | 175 | g/m² |
| | | | and | | |
| | | | Polyester | | |
| Bayex | 4501 | Non-woven | Fiberglass | 2.6 | lbs/100 F² |
| | | | and | | |
| | | | Polyester | | |
| Scrimco | 55007 | Non-woven | Fiberglass | 4.1 | lbs/100 F² |
| | | | and | | |
| | | | Polyester | | |
| Scrimco | 550018 | Non-woven | Fiberglass | 4.6 | lbs/100 F² |
| | | | and | | |
| | | | Polyester | | |
| Dylar | Spunbonded | Non-woven | Poly- | 140 | g/m² |
| | 140 | | propylene | | |
| Dylar | Spunbonded | Non-woven | Poly- | 160 | g/m² |
| | 160 | | propylene | | |
| Saint | RDO-81 | Knitted | Fiberglass | 8 | lbs/100 F² |
| Gobain | | | and | | |
| | | | Polyester | | |
| Milliken | 7101 | Knitted | Fiberglass | 9.4 | lbs/100 F² |
| | | | and | | |
| | | | Polyester | | |

As noted above, the base sheets of the present invention comprise a coating of a coal tar enamel on at least one surface of the fabric layer. Coal tar enamels generally are prepared by plasticizing coal tar pitch, for example by adding coal fines and a coal tar oil. Fillers may be added to the plasticized pitch. Examples of useful fillers include fine sand, talc, slate and/or mica. The resulting coal tar enamels soften on heating for easy application, and when cooled, the coal tar enamel forms a relatively hard, waterproof or water resistant coating.

In one embodiment, the coal tar enamels useful in the invention will have softening points in the range of about 90° C. to about 130° C. Softening points, as used herein, are determined in accordance with the ring and ball method of ASTM D36. In another embodiment the coal tar enamels used in this invention may be characterized as having a penetration in the range of from about 2 to about 20 at 77° F., 100 gr. 5 sec. as measured by ASTM D5, modified per AWWA 203. In yet another embodiment, the penetration of the coal tar enamel is in the range of from about 2 to about 10 at 77° F., 100 gr. 5 sec.

Coal tar enamels are available commercially from a variety of sources including Reilly Industries, NPG Industries Limited, and Porwal's Pipeline Protection. Specific examples of coal tar enamels available from Reilly Industries include Reilly 230-A Enamel (plasticized) characterized as having a minimum softening point of 99° C. (210° F.), a minimum penetration (77° F. 100 gr. 5 sec.) of 2 with a maximum of 9; Reilly AWWA, Type I, Enamel (fully-plasticized) characterized as having a minimum softening point of 104° C. (220° F.), a maximum softening point of 115° C. (240° F.), and a penetration (77° F. 100 gr. 5 sec.) of 5 and a maximum penetration of 10; Reilly AWWA, Type II, Enamel (fully plasticized) characterized as having a minimum softening point of 104° C. (220° F.), a maximum softening point of 115° C. (240° F.), a minimum penetration (77° F. 100 gr. 5 sec.) of 10 and a maximum penetration of 20; Reilly Hot Service Enamel characterized as having a minimum softening point of 115° C. (240° F.), a minimum penetration (77° F. 100 gr. 5 sec.) of 2 and a maximum penetration of 6. An example of a coal tar enamel available from NPG Industries Limited is the enamel identified by the general trade designation LOID T-11.

The coating of coal tar enamel may be applied to one or both surfaces of the fabric layers described above by techniques known to those skilled in the art. For example, the coal tar enamel may be applied to one or both surfaces of the fabric utilizing heated steel rollers which can be adjusted to provide the coal tar enamel coatings at different thicknesses and weights on the fabric. In one embodiment, the coal tar enamel is heated to a temperature above its softening point and then applied to the fabric. In one embodiment, the coal tar enamels are heated to temperatures in the range of from about 175° C. (350° F.) to about 220° C. (425° F.). In yet another embodiment, the coal tar enamel is heated to about 190 to about 210° C. and applied to the fabric at this temperature. The coal tar enamel should not be applied to polymeric fabrics at temperatures above the softening point of the polymer since this could result in destabilization of the fabric and reduce the effectiveness of the coal tar enamel coated fabric.

The amount of coal tar enamel applied to the fabric may be varied over a wide range as desired. In one embodiment, when only one surface of the fabric is coated, the coal tar enamel weight may range from about 5 pounds per 100 square feet to about 20 pounds per 100 square feet. When the coal tar enamel is applied to both surfaces of the fabric, the overall coal tar enamel weight may be in the range of from about 10 pounds per 100 square feet to about 40 pounds per 100 square feet.

In order to improve the antiblocking characteristics of the base sheets of the present invention, particularly when it is desired to form the sheets into rolls for storage and/or shipping, the outer surface of the coal tar enamel coating or coatings may be coated with a parting agent. In one embodiment, the parting agents utilized in the base sheets of the present invention comprise a liquid agent or a mineral agent capable of reducing blocking or sticking of the base sheet when the sheet is formed into a roll. Examples of parting agents (often referred to as release agents) include mica, sand, talc, or soaps. A useful specific example of parting agents include 100 mesh sand and Type 36 talc. In one embodiment, the parting agent is applied substantially evenly over the exposed surface(s). The amount of parting agent applied to the enamel coating(s) may vary over a wide range although the coating of parting agent should not increase the weight of the base sheet unnecessarily. In one embodiment, each side of the coated fabric will contain from about 0.03 to about 7 or 8 lbs. of parting agent per 100F². In another embodiment, each side of the coating may contain from about 1 to about 6 lbs/100 F².

In one embodiment, particularly when the coated base sheets of the present invention are to be utilized in roofing applications, stripes or lines may be applied to the enamel coating. These lines are utilized as a guide in laying one, two, three or four-ply systems. The ply stripes are important during application since they provide a means for proper alignment of the base sheets during application, and assist the applicator in providing the proper number of plies to the roof without some areas having fewer than the specified number.

In another embodiment, the base sheets of the present invention are coated on one side with a coal tar enamel as described above, and on the second side, the base sheet is coated with a coal tar composition. The coal tar compositions may comprise coal tar, coal tar pitch, and modified coal tar compositions such as a composition comprising coal tar, coal tar pitch, and copolymers of acrylonitrile and 1,3-butadiene. In one embodiment, the coal tars utilized as a second coating are coal tars having a float test of from about 50 seconds to about 220 seconds as determined by ASTM Test D139 entitled Test Method for Float Test for Bituminus Materials which is commonly used for testing the viscosity of semi solid bituminus materials. Such coal tars are of the type conventionally designated as RT-7 to RT-12 coal tars. The coal tar pitches which may be utilized are, in one embodiment coal tar pitches having a softening point of from about 140° C. to about 160° C. The coal tar compositions comprising coal tar, coal tar pitch and copolymers of acrylonitrile and 1,3-butadiene are described in, for example, U.S. Pat. No. 5,969,013, the disclosure of which is incorporated herein in its entirety. The amount of coal tar composition applied to the one side of the coal tar enamel coated base sheets of the present invention may be within the range of from about 1 to about 8 lbs. per 100 square feet or from about 1 to about 5 lbs. per 100 square feet. An antiblocking material as described above may also be applied to the side of the base sheet having the coal tar composition coating.

In some embodiments of the present invention, such as when one of the coating layers is a coal tar composition, the base sheets of the present invention may be combined with a release liner by contacting a release liner with the coated surface of the base sheet. The release liners provide an additional mechanism to prevent blocking of the base sheets when stacked or formed into rolls.

The release liners which may be utilized in the constructions of the present invention may comprise any of a variety of materials known to those skilled in the art to be suitable as release liners. In one embodiment, the release liner comprises a silicon coated paper substrate. Release coated polymer film substrates also may be used as release liners.

The process by which the coal tar enamel coated base sheets of the present invention are prepared may be summarized as follows. In one embodiment, the fabric is dried to remove any moisture which may be present. The dried fabric is then coated with the coal tar enamel utilizing any one of a large number of coating designs and processes available and known to those skilled in the art. In one embodiment, the method utilizes a coater which comprises a combination of heated rollers in a vat containing coal tar enamel maintained at an elevated temperature (e.g., from about 175° C. (350° F.) to about 230° C. (450° F.). The roller applies the hot coal tar enamel to the fabric, and the enamel begins to cool immediately after leaving the steel rollers. The rollers are also used to control the thickness of the coal tar enamel coating, thus effecting the finished product weight. The coal tar enamel at this stage is a semi-solid. In one embodiment, a fine mist of water is applied to the enamel coating whereupon the latent heat of the enamel causes the water to evaporate, and the temperature of the enamel is reduced. Optionally, a blocking material (e.g., sand) is applied evenly over the top of the coated fabric, and after further cooling and passing over additional rollers or cooling drums, blocking agent is applied to the back of the coated fabric. The fabric then proceeds over additional cooling drums, and ply lines are optionally applied to the fabric. Following additional cooling, the fabric is cut into desired shapes or wound into rolls. The rewind station rolls the membrane into finish length and width dimensions.

The following examples illustrate the preparation of the coal tar enamel coated fabrics of the present invention. Unless otherwise indicated in the following Examples, in the specification or elsewhere in the written description, all parts and percentages are by weight, temperatures are in degrees Celsius, and pressure is at or near atmospheric pressure.

### EXAMPLE 1

The fabric which is utilized in this example is a non-woven fiberglass fabric commercially available from Johns Manville in roll form and identified as JM Duramat 7542. This fabric has a mass of 1.85 lbs./100F² and an ash content of 75%.

The coal tar enamel utilized in this example is available from Reilly Chemical and is identified as AWWA, Type I, Enamel (fully plasticized). This enamel has a softening point (ASTM D-36) in the range of 104° C. (220° F.) to 115° C. (240° F.), and a penetration (ASTM D-5) in the range of 5-10 at 77° F., 100 gr., 5 sec.

The coal tar enamel is agitated and heated to a temperature of about 110° C. (430° F.) in a bulk storage tank, and this temperature is maintained throughout the coating process. The non-woven fiberglass fabric is unwound from the roll, dried and advanced through a coater which comprises a combination of heated rollers in a vat. The speed of the fabric through the coater is about 180 feet per min. and the fabric is maintained under tension to maintain the integrity of the fabric as it passes through the coater. The heated coal tar enamel is pumped from the bulk storage tank into the coater, and the enamel is also pumped from the coater to the top of the fabric just prior to the adjustable steel rollers. The bottom of the fabric is coated by a roller that is partially submerged in the enamel contained in the vat and driven SO as to apply tar from the vat to the fabric. This roller is sometimes referred to as an inking roller. The application of the coal tar enamel to the fabric is controlled within the coater to provide a total thickness (fabric plus enamel) of about 40 mils. The coal tar enamel begins to cool immediately after leaving the steel rollers, and a fine mist of water subsequently is applied to the enamel to further reduce the temperature of the enamel whereupon fine sand is applied over the top of the coated fabric. After traveling over cooling drums, additional fine sand is applied to the back of the coated fabric. In this example, the sand is applied to each side of the coated fabric at a rate of about 5 lbs./100F². Ply lines are applied to the coated fabric and the fabric is further cooled and rewound into a roll. Typical roll dimensions are 36″ width by 108″ length (3 square yield), and the roll weight is about 70 lbs. The roll weight comprises 6 lbs. of the raw non-woven fiberglass fabric, 10 lbs. of sand (parting agent) substantially evenly distributed on both sides, and 54 lbs. of coal tar enamel.

### Example 2

The procedure of Example 1 is repeated utilizing a high strength knitted fabric comprising a blend of fiberglass and polyester. The particular fabric utilized in this example is available from Milliken under the designation Milliken 7101 fabric. The coal tar enamel in this example is heated to and maintained in the bulk storage tank and in the coater to a temperature of about 175° C. (350° F.).

While the invention has been explained in relation to its various embodiments, it is to be understood that other modifications thereof will become apparent to those skilled in the art upon reading the specification. Therefore, it is to be understood that the invention disclosed herein is intended to cover such modifications as fall within the scope of the appended claims.

1. A roofing system comprising a preformed base sheet comprising:
(a) a fabric layer having an upper surface and a lower surface, and
(b) a coating of a coal tar enamel on at least one surface of the fabric, the coating having an exposed outer surface.

2. The roofing system of claim 1 wherein the fabric comprises fibers and/or filaments selected from glass, polymeric materials, and mixtures thereof.

3. The roofing system of claim 1 wherein the fabric comprises fiberglass.

4. The roofing system of claim 1 wherein the fabric comprises polyolefins, polyamides, polyesters, or mixtures thereof.

5. The roofing system of claim 1 wherein the fabric is a knitted fabric.

6. The roofing system of claim 1 wherein the fabric is a non-woven fabric.

7. The roofing system of claim 1 wherein both surfaces of the fabric are coated with the coal tar enamel.

8. The roofing system of claim 1 wherein the coal tar enamel has a softening point in the range of from about 90° C. to about 130° C.

9. The roofing system of claim 1 wherein the coal tar enamel has a penetration in the range of from about 2 to about 20, 77° F., 100 gms, 5 seconds as measured by ASTM D5.

10. The roofing system of claim 1 wherein the base sheet also comprises (c) a coating of a parting agent on the exposed surface of the coal tar enamel.

11. The roofing system of claim 10 wherein the parting agent comprises a liquid agent or a mineral agent capable of reducing blocking of the base sheet when the sheet is formed in a roll.

12. The roofing system of claim 1 wherein the upper surface of the base sheet is coated with a coal tar enamel, and the lower surface of the base sheet is coated with a different coal tar composition.

13. The roofing system of claim 1 wherein the upper surface of the base sheet is coated with a coal tar enamel, and the lower surface of the base sheet is coated with a modified coal tar composition comprising coal tar, coal tar pitch and a copolymer of acrylonitrile and 1,3-butadiene.

14. The roofing system of claim 12 wherein the base sheet also comprises a release liner in contact with the exposed surface of the coal tar coating.

15. A roofing system comprising a preformed base sheet comprising:
(a) a fabric layer having an upper surface and a lower surface,
(b) a coating of a coal tar enamel on both surfaces of the fabric, each coating having an exposed outer surface, and
(c) a coating of a parting agent on at least one of the exposed outer surfaces of the coal tar enamel coatings.

16. The roofing system of claim 15 wherein the fabric comprises fibers and/or filaments selected from glass, polyolefins, polyesters, polyamides and mixtures of two or more thereof.

17. The roofing system of claim 15 wherein the fabric is a non-woven or a knitted fabric.

18. The roofing system of claim 15 wherein the fabric is a non-woven polyester fabric.

19. The roofing system of claim 15 wherein the fabric is a non-woven fiberglass fabric.

20. The roofing system of claim 15 wherein the fabric is a knitted fabric.

21. The roofing system of claim 15 wherein the fabric comprises fiberglass and a polyester.

22. The roofing system of claim 15 wherein the coal tar enamel has a softening point in the range of from about 90° C. to about 130° C.

23. The roofing system of claim 15 wherein the coal tar enamel has a penetration in the range of from about 2 to about 20, 77° F., 100 gms, 5 seconds as measured by ASTM D5.

24. The roofing system of claim 15 wherein the coal tar enamel has a penetration in the range of from about 2 to about 10, 77° F., 100 gms, 5 seconds as measured by ASTM D5.

25. The roofing system of claim 15 wherein the weight of coal tar enamel coating is in the range of from about 10 to about 40 lbs per hundred square feet.

26. The roofing system of claim 15 wherein the weight of the fabric layer is in the range of from about 1.5 to about 10 lbs per hundred square feet.

27. The roofing system of claim 15 wherein the weight of the parting agent is in the range of from about 0.3 lbs to about 10 lbs per hundred square feet.

28. The roofing system of claim 15 which is waterproof.

29. The roofing system of claim 1 wherein the preformed base sheet is used as a ply sheet in a cold process roof assembly or as a base sheet and/or flashing in an asphalt or coal tar built-up roofing system.

30. The roofing system of claim 1 wherein the preformed base sheet is used as flashing.

31. The roofing system of claim 15 wherein the preformed base sheet is used as flashing.
